(19) United States
(12) Patent Application Publication
(10) Pub. No.: US 2026/0085819 A1
(43) Pub. Date: Mar. 26, 2026

(54) SYSTEM AND METHOD FOR PRODUCING OMNIDIRECTIONAL LIGHT

(71) Applicant: Maksim Glazer, Nessebar (BG)

(72) Inventor: Maksim Glazer, Nessebar (BG)

(21) Appl. No.: 18/896,974

(22) Filed: Sep. 26, 2024

(51) Int. Cl. F21V 17/10; F21V 3/02; F21V 3/06

(52) U.S. Cl. CPC F21V 17/102; F21V 3/02; F21V 3/0625

(57) ABSTRACT

Disclosed herein is an optical diffuser including a compressible, elastic polymeric bulk having an exterior portion for diffusion of light received from a light emitting surface, a planar mounting surface configured to seal against light emitting surface, and an atmospheric gas-filled cavity within bulk, cavity terminating at an opening within planar mounting surface, cavity has a first volume when bulk is at rest and a second, reduced volume when bulk is compressed, such that when planar mounting surface is placed in full engagement with light emitting surface so as to form a planar contact interface therewith, application of a momentary inward compressive force of the elastic polymeric bulk expels gas from within the cavity, and subsequent removal of the compressive force facilitates elastic recovery of bulk, thereby to give rise to a partial vacuum within cavity, and causing optical diffuser to adhere to light emitting surface under a suction force.

### FIELD

The disclosed subject matter is in the field of lighting accessories for smart devices.

### BACKGROUND

Most smart mobile devices are equipped with embedded flashlights. There are also external flashlight devices for these smart mobile devices.

### SUMMARY

The following embodiments and aspects thereof are described and illustrated in conjunction with systems, tools and methods which are meant to be exemplary and illustrative, not limiting in scope.

There is provided, in accordance with an embodiment, an optical diffuser including a compressible, elastic polymeric bulk having an exterior portion for diffusion of light received from a light emitting surface, a planar mounting surface configured to seal against the light emitting surface, and an atmospheric-gas-filled cavity within the bulk, the cavity terminating at an opening within the planar mounting surface, the cavity has a first volume when the bulk is at rest and a second, reduced volume when the bulk is compressed, such that when the planar mounting surface is placed in full engagement with the light emitting surface so as to form a planar contact interface therewith, application of a momentary inward compressive force of the elastic polymeric bulk expels gas from within the cavity, and subsequent removal of the compressive force facilitates elastic recovery of the bulk, thereby to give rise to a partial vacuum within the cavity, and thereby to cause the optical diffuser to adhere to the light emitting surface under a suction force.

In some embodiments, the optical diffuser is configured such that the suction force is greater than or equal to the maximum turning moment caused by the weight of the bulk and the angular disposition of the planar contact interface.

In some embodiments, the polymeric bulk is polyhedral, and the planar mounting surface is polygonal.

In some embodiments, the polymeric bulk is cylindrical and the planar mounting surface is circular.

There is further provided, in accordance with an embodiment, a method of diffusing light received from a light emitting surface, which includes the steps of providing a compressible, elastic polymeric bulk having an exterior portion for diffusion of light received from a light emitting surface, a planar mounting surface, and an atmospheric gas-filled cavity within the bulk, the cavity terminating at an opening within the planar mounting surface; applying an inward compressive force to the elastic polymeric bulk so as to expel gas from within the cavity; holding the planar mounting surface against the light emitting surface in full engagement therewith, and removing the compressive force from the bulk so as to facilitate elastic recovery thereof, thereby to give rise to a partial vacuum within the cavity, and to cause the optical diffuser to adhere to the light emitting surface under a suction force.

There is further provided, in accordance with an embodiment, a system including a smart device including a touchscreen, a processor coupled to the touchscreen, the processor configured to execute a light emitting application so as to activate at least one light emitting portion of the touchscreen, an optical diffuser including a compressible, elastic polymeric bulk having an exterior portion for diffusion of light received from a light emitting portion of the touchscreen, a planar mounting surface configured to seal against the light emitting surface, and an atmospheric gas-filled cavity within the bulk, the cavity terminating at an opening within the planar mounting surface, the cavity has a first volume when the bulk is at rest and a second, reduced volume when the bulk is compressed, such that when the planar mounting surface is placed in full engagement with the light emitting surface so as to form a planar contact interface therewith, application of a momentary inward compressive force of the elastic polymeric bulk expels gas from within the cavity, and the subsequent removal of the compressive force facilitates elastic recovery of the bulk, thereby to give rise to a partial vacuum within the cavity, and thereby to cause the optical diffuser to adhere to the light emitting surface under a suction force.

In some embodiments, the optical diffuser is configured such that the suction force is greater than or equal to the maximum turning moment caused by the weight of the bulk and the angular disposition of the planar contact interface.

In some embodiments, the polymeric bulk is polyhedral, and the planar mounting surface is polygonal.

In some embodiments, the polymeric bulk is cylindrical and the planar mounting surface is circular.

In some embodiments, the processor is further configured to receive at least one command input to initiate the light emitting application.

In some embodiments, the processor is further configured to display a selectable command for activation of the light emitting portion of the touchscreen.

In some embodiments, the processor is further configured to display a timer setting, an audio volume setting and a brightness setting on the touchscreen.

In some embodiments, the exterior portion is a diffractive optical material configured to diffract monochromatic light into a predetermined spatial configuration and intensity profile.

In some embodiments, the planar mounting surface comprises an adhesive layer.

In addition to the exemplary aspects and embodiments described above, further aspects and embodiments will become apparent by reference to the figures and by study of the following detailed description.

### BRIEF DESCRIPTION OF THE FIGURES

Some non-limiting exemplary embodiments or features of the disclosed subject matter are illustrated in the following drawings. Identical, duplicate, equivalent or similar structures, elements or parts that appear in one or more drawings are generally labeled with the same reference numeral, optionally with an additional letter or letters to distinguish between similar entities or variants of entities and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different points of view.

References to previously presented elements are implied without necessarily further citing the drawing or description in which they appear.

FIGS. 1A-1B are schematic illustrations of a system for generating an omnidirectional light from a directional light source, according to certain exemplary embodiments;

FIG. 2 is a schematic illustration of a smart device of the system of FIGS. 1A-1B configured to produce directional light, according to certain exemplary embodiments;

FIGS. 3A-3D are schematic illustrations of three-dimensional geometric configurations for the optical diffuser of the system of FIGS. 1A-1B, according to certain exemplary embodiments;

FIG. 4A-4B are schematic illustrations showing the positioning of the optical diffuser of FIG. 1A on a touchscreen of the smart device of FIG. 1A, according to certain exemplary embodiments;

FIG. 5 is a cross-sectional view of a diffuser of FIG. 1A, according to certain exemplary embodiments;

FIGS. 6A-6E are schematic illustrations of an application interface configured to facilitate the emission of directional light from the touchscreen of the smart device of FIGS. 1A-1B, according to certain exemplary embodiments;

FIG. 7 is a flow chart of a method for positioning the diffuser of FIGS. 1A-1B on the touchscreen of the smart device of FIG. 1A so as to emit omnidirectional light from the diffuser, according to certain exemplary embodiments;

FIG. 8 is a flow chart of a method for operating the smart device of FIGS. 1A-1B to emit directional light, according to certain exemplary embodiments;

FIG. 9 is a schematic illustration of a cross-sectional view of an optical diffuser having a cavity, according to certain exemplary embodiments;

FIG. 10A is a cross-sectional view of a self-adhering optical diffuser, in accordance with some exemplary embodiments;

FIG. 10B is a bottom view of the optical diffuser of FIG. 10A;

FIG. 11 is a side perspective view of the self-adhering optical diffuser of FIGS. 10A and 10B before adherence to a light emitting surface, during application of a compressive force, in accordance with some exemplary embodiments;

FIG. 12 is a partially cut-away view of the diffuser as shown in FIG. 11, following removal of the compressive force and elastic recovery of the diffuser, showing a pressure differential between the interior and exterior of the diffuser, giving rise to a suction force across an interface between the diffuser and the light emitting surface, in accordance with some exemplary embodiments;

FIG. 13 is a side view showing the suction force resisting the maximum turning moment of the diffuser when the light emitting surface is vertical and the diffuser is horizontally disposed, in accordance with some exemplary embodiments; and

FIGS. 14A-14E schematically illustrate optical diffuser with a plurality of geometric configurations, according to some exemplary embodiments.

### DETAILED DESCRIPTION

Disclosed herein is a system and method for emitting directional light from a touchscreen of a smart device through a diffuser to produce omnidirectional light, according to certain exemplary embodiments.

In the context of some embodiments of the present disclosure, without limiting, a bulk is/implies a large, continuous quantity of polymer material that is not in a granular or powdered form but rather in a more solid, dense form which is a sizable chunk or mass of polymer material.

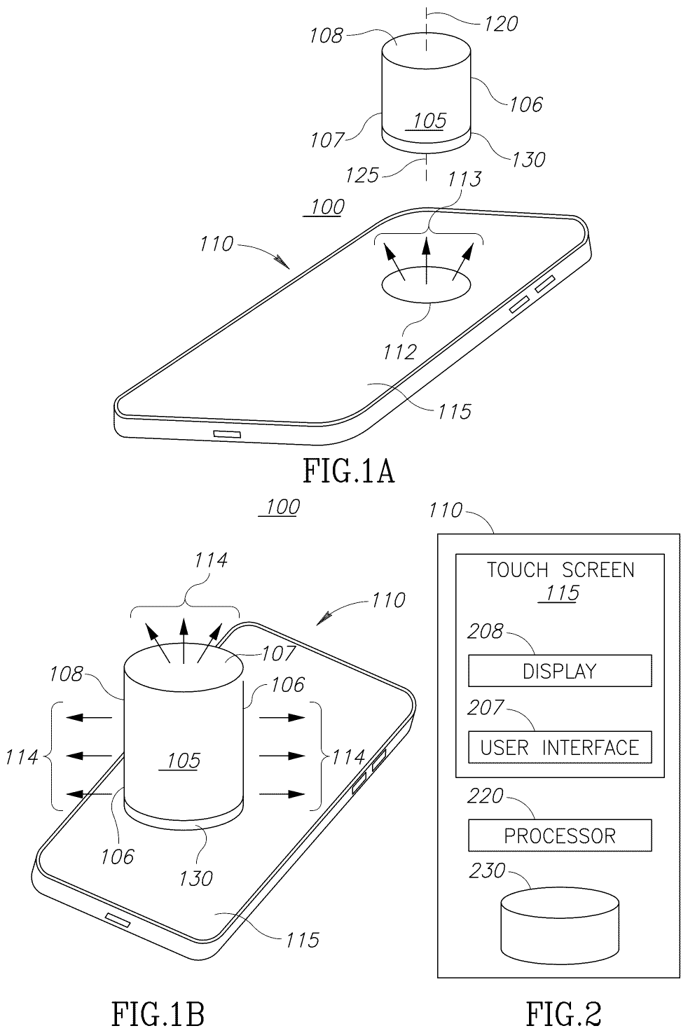

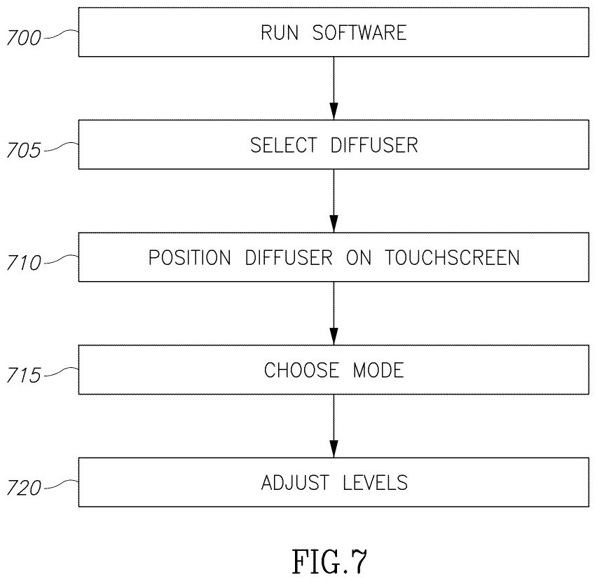

FIGS. 1A-1B are schematic illustrations of a system 100 for generating omnidirectional light from directional light, according to certain exemplary embodiments. With reference to FIG. 1A, system 100 includes a smart device 110, such as a smartphone, a tablet, or the like, which is configured to emit directional light 113 from a light emitting portion 112 of a light emitting surface, such as a touchscreen 115. In some embodiments, light emitting portion 112 can be a graphical display of light that is displayed from touchscreen 115 at a predetermined brightness. In some embodiments, smart device 110 executes a computer program product for running an application 600 (FIG. 6), the computer program including a non-transitory computer-readable storage medium having program code, as further described in conjunction with FIGS. 6A-6C herein below.

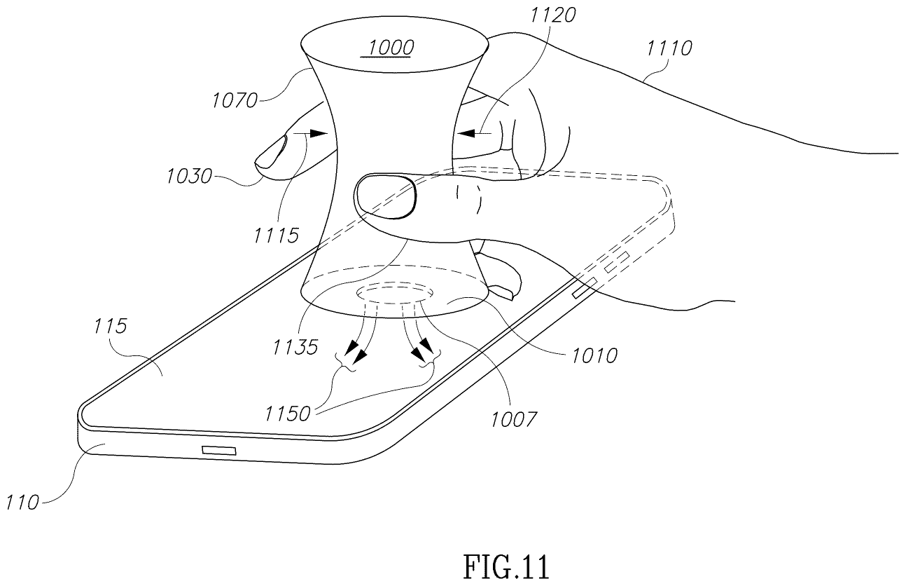

System 100 includes an optical diffuser 105 having a proximal end 120 and a distal end 125. Optical diffuser 105 includes a connection element 130 at distal end 125 to facilitate connecting optical diffuser 105 to a light emitting surface, such as touchscreen 115 as further illustrated in FIG. 1B. Distal end 125 is arranged vertically from touchscreen 115 to facilitate connection of connection element 130 to touchscreen 115. The connection element is geometrically configured to cover the entirety of light emitting portion 112 to prevent directional light emitting outside the boundaries of optical diffuser 105. Directional light 113 emitted into optical diffuser 105 disperses from surfaces 106, 107, 108 of optical diffuser 105 as omnidirectional light 114. In some embodiment, connection element 130 is configured to connect to touchscreen 115 thereby preventing optical diffuser 105 from detaching from smart device 110 during use of optical diffuser 105. In some exemplary embodiments, connection element 130 can be an adhesive material layer, a suction cup, a planar mounting surface 1010 (FIGS. 10A-10B), or the like.

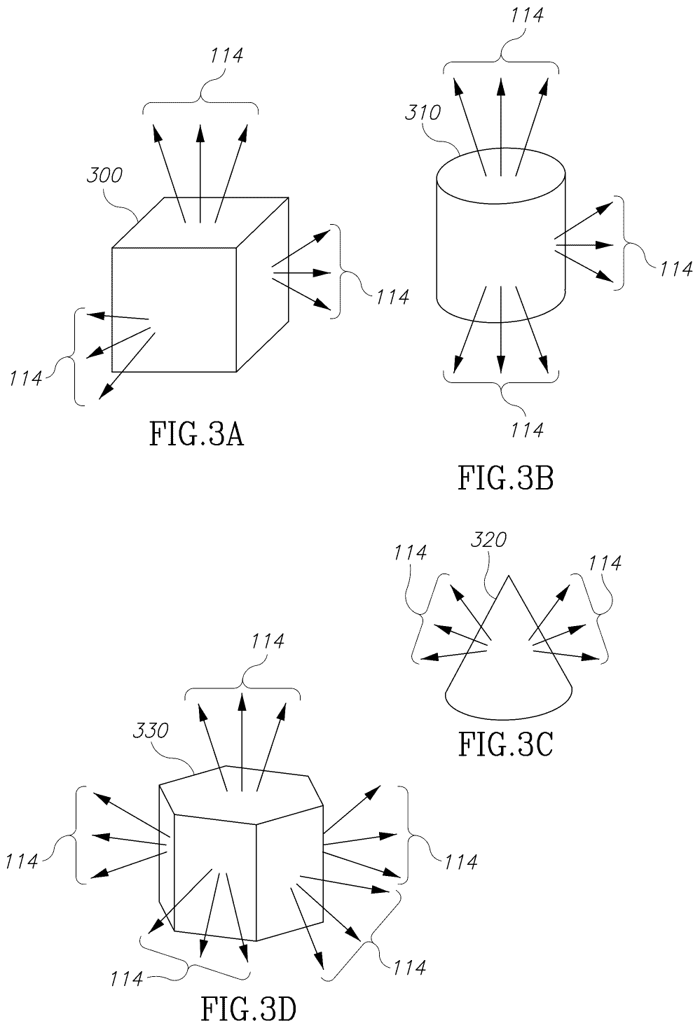

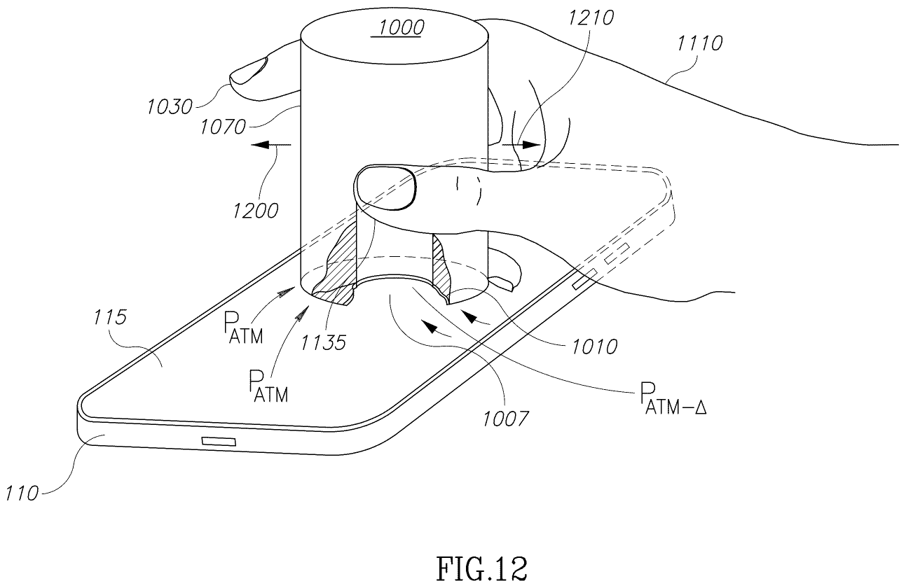

With reference to FIG. 2, which is a schematic illustration of smart device 110, according to certain exemplary embodiments. Touchscreen 115 includes a user interface 207 configured to facilitate receiving command inputs from a user 1110 (FIG. 11) to operate smart device 110 to emit directional light 113 (FIG. 1A). For example, the user can provide one or more command inputs to smart device 110. In some embodiments, touchscreen 115 includes a light emitting portion 112 (FIG. 1A) in display 208 that emits direction light 113. It is understood that display 208 is integral to touchscreen 115 and where it is described that touchscreen 115 is emitting or displaying light emitting portion 112 and emitting directional light 113, it is performed via display 208.

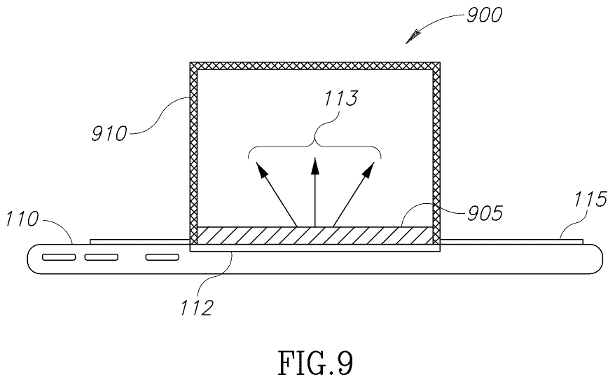

Smart device 110 includes a processor 220. Processor 220 is coupled to touchscreen 115 and configured to execute a light emitting application for activating light emitting portion for emitting directional light in a predetermined geometric configuration that corresponds to a geometric configuration of optical diffuser 105 (FIG. 1A), as further detailed in conjunction with FIG. 6 below. Processor 220 is configured to execute a computer program product for running an application 600 (FIG. 6), the computer program including a non-transitory computer-readable storage medium having program code, as further described in conjunction with FIG. 8 below herein. Smart device 110 includes a memory 230 configured for storing the computer program product. In some embodiments, the light application can provide control features for time duration of the light, brightness of the light, geometric configuration of the light or the like.

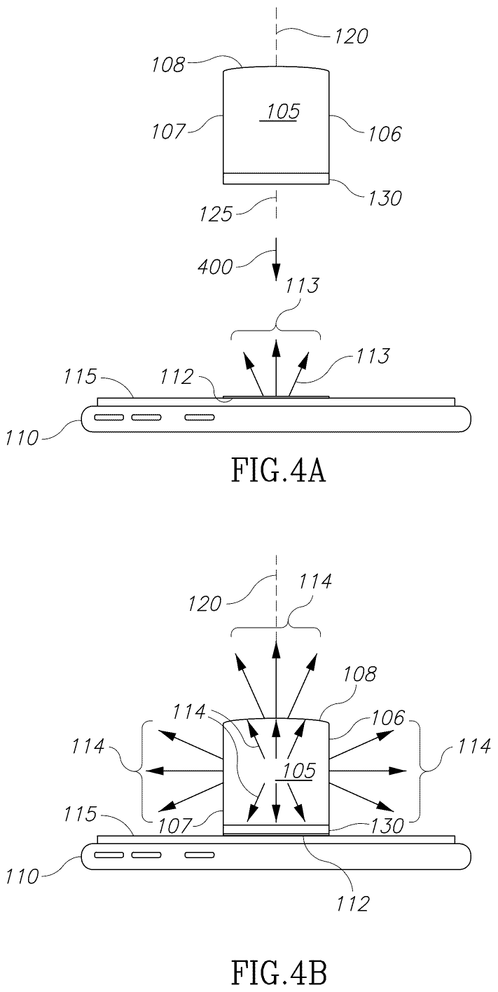

FIGS. 3A-3D are schematic illustrations of a plurality of three-dimensional geometric configurations of a plurality of optical diffusers, according to certain exemplary embodiments. One skill in the art will understand that the three-dimensional configurations described in FIGS. 3A-3D are exemplary embodiments for optical diffuser 105 of FIGS. 1A-1B.

As schematically illustrated in FIG. 3A, optical diffuser 300 can have a cubical configuration 300.

As schematically illustrated in FIG. 3B optical diffuser 310 has a cylindrical configuration.

As schematically illustrated in FIG. 3C, optical diffuser 320 can have a cone shaped configuration,

As schematically illustrated in FIG. 3D, optical diffuser 330 can have a pentagonal configuration 330.

One skilled in the art would understand that each optical diffuser configuration is configured to emit omnidirectional light 114 evenly from all surfaces of optical diffuser 300, 310, 320, 330. Furthermore, one skilled in the art would understand that the geometric configurations are non-limiting and any geometric configuration can be implemented for optical diffuser 105.

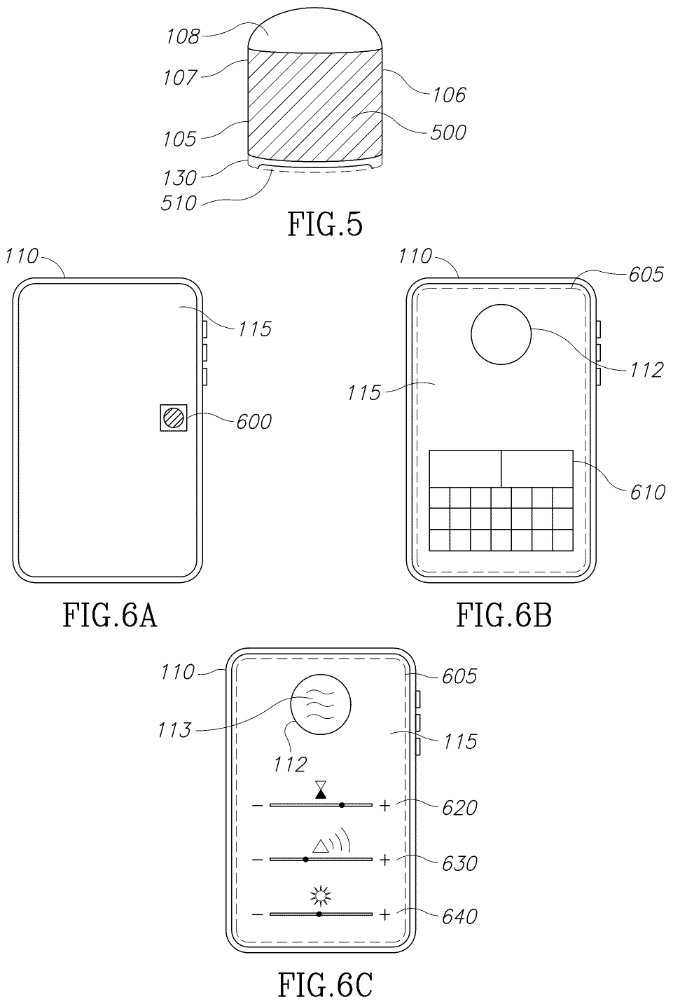

With reference now to FIGS. 4A-4B, which are schematic illustrations of positioning optical diffuser 105 on touchscreen 115, according to certain exemplary embodiments. In FIG. 4A, Optical diffuser 105 is arranged such that distal end 125 is vertically above touchscreen 115 and proximal end 120 is directed away from touchscreen 115. In FIG. 4A, as represented by arrow 400, optical diffuser 105 is moved towards touchscreen 115 until distal end 125 is connected to touchscreen 115.

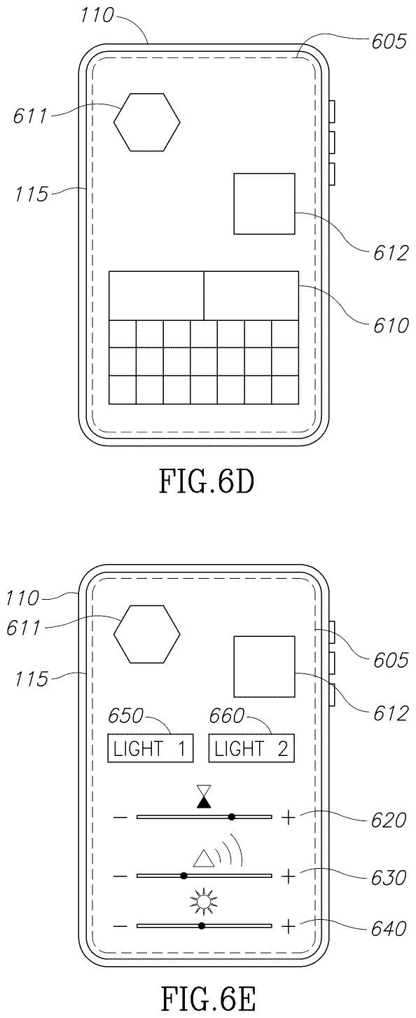

FIG. 5 is a schematic illustration of a cross-sectional view of optical diffuser 105, according to certain exemplary embodiments of the subject matter. In some embodiments, optical diffuser 105 is composed from a light diffusing material 500 that can spread direct light 113 (FIG. 1A) and spread it in a manner that produces softer light 114. For example, the light diffusing material 500 can be opal glass, ground glass, Teflon or the like. In some embodiments, optical diffuser 105 can be composed from a light diffusing material 500 configured to diffract monochromatic light into a predetermined spatial configuration and intensity profile. In such embodiments, light diffusing material 500 is made from fused silica, gallium nitride (“GaN”) or the like. In some exemplary embodiments, connection element 130 is composed of a transparent material thereby allowing all of directional light 113 to transfer into light diffusing material. In some other exemplary embodiments, connection element 130 can include an opening 510 to facilitate directing directional light 113 (FIG. 1A) into light diffusing material 500.

FIGS. 6A-6E are schematic illustrations of operating an application to emit light from the smart device 110, according to certain exemplary embodiments. With reference to FIG. 6A, touchscreen 115 displays a light emitting application icon (“icon”) 600. When a user interacts with icon 600, for example by pressing icon 600, smart device 110 initiates a light emitting application for emitting light 112 (FIG. 1A).

With reference to FIG. 6B, after the application is activated, an application interactive display 605 is displayed on touchscreen 115. The application presents a light emitting portion 112 and a menu 610 are displayed in application display 605, according to certain exemplary embodiments. Menu 610 is configured to facilitate activating light emitting portion 112 to emit a light 113 (FIG. 6C). In some exemplary embodiments, a user can utilize menu 610 to select the geometric configuration of the of the light emitting area so that it matches the geometric configuration of optical diffuser 105 (FIG. 1A). In some exemplary embodiments, menu 610 facilitates selecting a light color, a preliminary brightness level, a location of light emitting portion 112 on touchscreen 115, or the like.

With reference to FIG. 6C, application display 605 can display customization options, such as a timer setting 620, audio volume setting 630 and brightness settings 640, according to certain exemplary embodiments. For example, timer setting 620 facilitates setting a length of time for light to be emitted from the light emitting portion 112, the audio volume setting 630 facilitates changing a volume of an audio media file being played by smart device 110 (FIG. 1A), and brightness setting 640 can facilitate increasing or decreasing the brightness of light 113 being emitted from light emitting portion 112.

With reference to FIGS. 6D-6E, application display 605 can include one or more light emitting areas, for example, a first light emitting area 611 and a second light emitting area 612. First light emitting portion 611 and second light emitting portion 612 can include different geometric configurations. For example, first light emitting portion 611 can have an octagonal shape and second light emitting portion 612 can have a square shape to facilitate use of optical diffusers with different geometric configurations. Menu 610 facilitates configuring one or more light emitting areas to match the geometric configuration of preselected optical diffusers. As illustrated in FIG. 6E, application display 605 can include selectors 650, 660 to alternate the controls for first light emitting portion 611 and second light emitting portion 612.

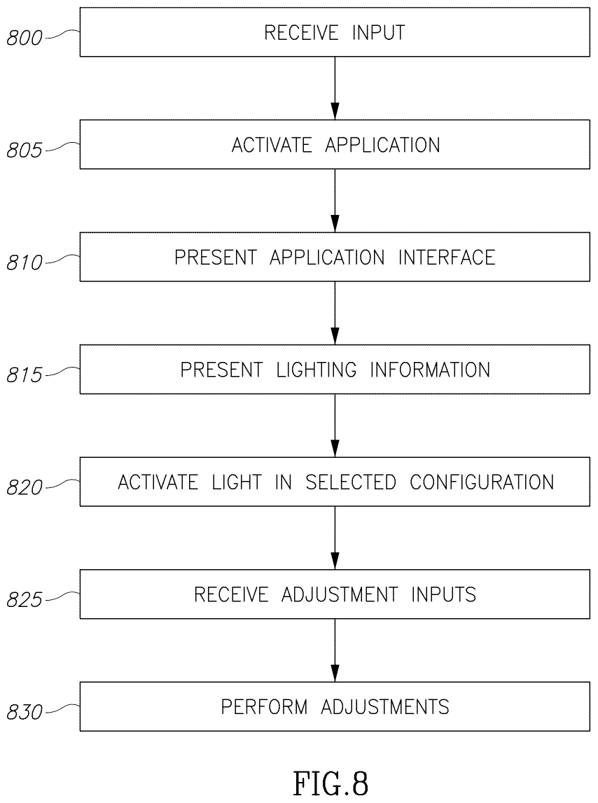

FIG. 7 shows a flow chart of a method for positioning smart device optical diffuser 105 (FIG. 1A) on the smart device 110 (FIG. 1A), according to certain exemplary embodiments. In step 700, a user interacts with smart device 110 to run software of light application.

In step 705, the user selects optical diffuser 105, for example, one of the optical diffusers illustrated in FIGS. 3A-3D.

In step 710, the user positions optical diffuser 105 on touchscreen 115 (FIG. 1A). Optical diffuser 105 is positioned on light emitting portion 112 (FIG. 1A) to facilitate ambient light 114 (FIG. 1B) emittance.

In step 715, the user selects a mode of operation using the application, as further detailed above in conjunction with FIG. 6B.

In step 720, the user can adjust the levels of the light through the application. The user can adjust the levels as detailed above in conjunction with FIG. 6C.

FIG. 8 shows a flow chart of a method for operating smart device 110 (FIG. 1) to direct light through optical diffuser 105 (FIG. 1), according to certain exemplary embodiments. In operation 800, processor 220 (FIG. 2) receives a command input from user interface 207 (FIG. 2) to initiate a light emitting application 600 (FIG. 6A). The command input is received through user interface 207, for example, by engagement of touchscreen 115 where application 600 is presented on touchscreen 115.

In operation 805, processor 220 executes light emitting application 600. Processor 220 executes the software commands stored in memory 230 (FIG. 2) to activate light emitting application 600.

In operation 810, processor 220 presents application interactive display 605 (FIG. 6A) on touchscreen 115 (FIG. 1A).

In operation 815, processor 220 operates touchscreen 115 to present one or more light emitting areas (FIG. 6D). Processor 220 is configured to display a selectable command for activation of the light emitting portion of touchscreen 115.

In operation 820, processor 220 operates touchscreen 115 to display one or more directional lights in the selected configuration.

In operation 825, processor 220 receives adjustment inputs, such as brightness settings, timer settings, volume settings, or the like, as described in conjunction with FIGS. 6C and 6E.

In operation 830, processor 220 executes the adjustments to light emitting portion 112 (FIG. 6C) or first light emitting area 611 and second light emitting area 612 (FIG. 6E).

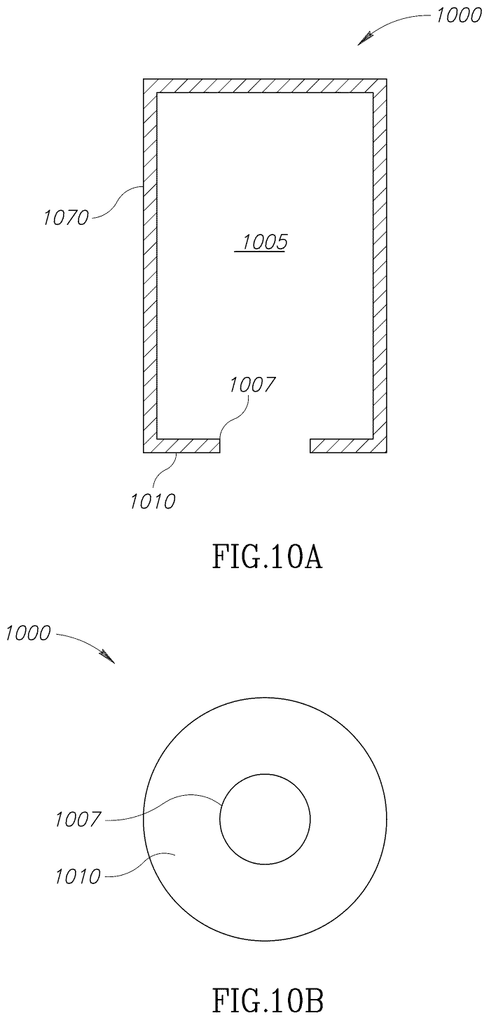

FIG. 9 is a longitudinal cross-sectional view of a optical diffuser 900 having a cavity 901, according to certain exemplary embodiments. In some exemplary embodiments, directional light 113 passes through connection element 905 into cavity 901 and dispersed from there through light diffusing material 910. Connection element 905 is composed of a transparent material, for example, transparent plastic or the like, that facilitates transfer of directional light 113 into cavity 901.

FIG. 10A is an isometric view of a self-adhering optical diffuser 1000, in accordance with some exemplary embodiments. Self-adhering optical diffuser (“optical diffuser”) 1000 is a compressible, elastic polymeric bulk having an exterior portion 1070 for diffusion of light received from light emitting surface, such as touchscreen 115 (FIG. 1) and a planar mounting surface 1010 configured to seal against the light emitting surface. Optical diffuser 1000 includes an atmospheric gas-filled cavity 1005 within the bulk. Cavity 1005 terminates at an opening 1007 within planar mounting surface 1010. The subsequent removal of the compressive force facilitates elastic recovery of the bulk, thereby giving rise to a partial vacuum within cavity 1010, and thereby cause optical diffuser 1000 to adhere to the light emitting surface under a suction force. In some embodiments, the elastic polymeric bulk can be polyhedral, cylindrical, or the like. In some embodiments, the elastic bulk material can be from silicone, rubber, flexible plastics or the like.

According to a shore hardness value of the elastic polymeric bulk and size of optical diffuser 1000, the width or thickness of the exterior portion 1070 can be within a range of 1-4 millimeters (“mm”) and bottom portion 1010 can have a width or thickness within a range of 1-3 mm. For example, a cylindrical shaped optical diffuser 1000 has an exterior portion 1070 with a thickness of 3 mm and a bottom portion 1010 with a thickness of 2 mm.

FIG. 10B is a bottom view of optical diffuser 1000 showing a circular planar mounting surface 1010 with opening 1007, in accordance with some exemplary embodiments.

FIG. 11 is a side perspective view of optical diffuser 1000 before adherence to a touchscreen 115, during application of a compressive force, in accordance with some exemplary embodiments. Cavity 1005 (FIG. 10A) has a first volume when the bulk is at rest and a second, reduced volume when the bulk 1070 is compressed. In some embodiments, touchscreen 115 is a planar mounting surface that is polygonal, circular or the like. When planar mounting surface 1010 is placed in full engagement with touchscreen 115 so as to form a planar contact interface therewith, application of a momentary inward compressive force 1115 of the elastic polymeric bulk 1070 expels gas 1150 from within the cavity 1005. For example, a user 1110 applies inward compressive force 1115 with a thumb 1135 and index finger 1030, which expels gas 1150 from cavity 1005.

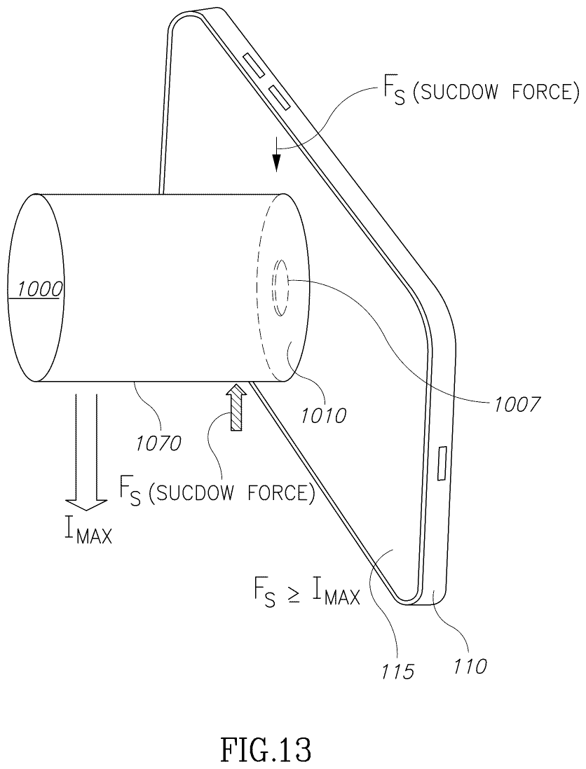

FIG. 12 is a partially cut-away view of the diffuser, following removal of the compressive force 1115 (FIG. 11) and elastic recovery 1200 of optical diffuser 1000. The removal of compressive force 1115 results in a pressure differential between the interior pressure (P_{ATM-Δ}) and exterior pressure (P_{ATM}) of optical diffuser 1000 giving rise to a suction force, F_{S(SUCDOW FORCE)}, across planar mounting surface 1010 and touchscreen 115 resulting in planar mounting surface 1010 adhering to touchscreen 115.

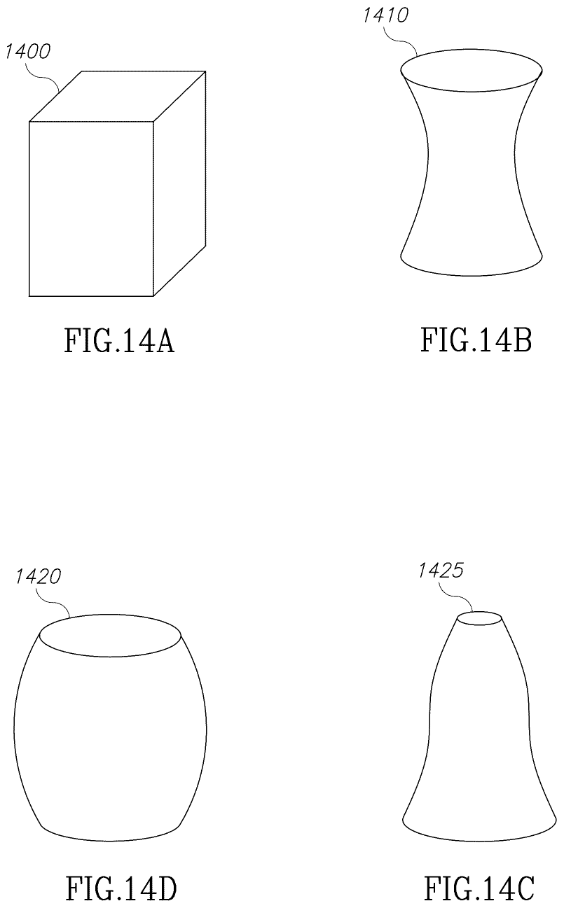

FIG. 13 is a side view showing the suction force resisting the maximum turning moment of the optical diffuser 1000 when touchscreen 115 is vertical and optical diffuser 1000 is horizontally disposed, in accordance with certain exemplary embodiments. Optical diffuser 1000 is configured such that the suction force (F_{S(SUCDOW FORCE)}), is greater than or equal to the maximum turning moment, IMAX, caused by the weight of the bulk and the angular disposition of the planar contact interface, such that F_{S}≥I_{MAX}.

In some embodiments, a method of diffusing light by optical diffuser 1000 received from a light emitting surface, such as touchscreen 115, includes user 1110 performing the steps of:
Providing compressible, elastic polymeric bulk 1070 having exterior portion for diffusion of light received from touchscreen 115, planar mounting surface 1010, and an atmospheric gas-filled cavity 1005 (FIG. 10A) within the bulk, cavity 1005 terminating at an opening 1007 within planar mounting surface 1010, as described in conjunction with FIG. 11.
Applying an inward compressive force 1115 to the elastic polymeric bulk 1070 so as to expel gas 1150 from within the cavity 1005, as described in conjunction with FIG. 11.
Holding planar mounting surface 1010 against touchscreen 115 in full engagement therewith.
Removing the compressive force 1115 from bulk 1070 so as to facilitate elastic recovery 1200 thereof, thereby to give rise to a partial vacuum within cavity 1005, and to cause optical diffuser 1000 to adhere to touchscreen 115 under a suction force F_{S(SUCDOW FORCE)}, as described in conjunction with FIGS. 12A-12B.

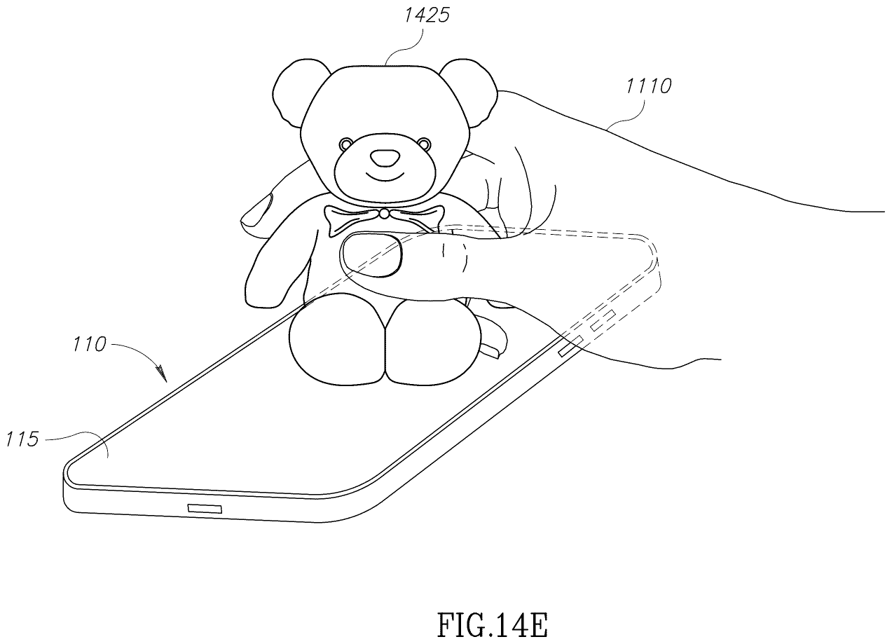

FIGS. 14A-14E schematically illustrate optical diffusers with a plurality of geometric configurations, according to some exemplary embodiments. Optical diffuser 1000 can be arranged in a geometric configuration of a rectangle 1400, a funnel 1410, a barrel 1420, geometrically ambiguous 1425, a shape of an animal, such as a teddy bear 1425, or the like.

The present invention may be a system, a method, and/or a computer program product. The computer program product may include a computer readable storage medium (or media) having computer readable program instructions thereon for causing a processor to carry out aspects of the present invention.

In the context of some embodiments of the present disclosure, by way of example and without limiting, terms such as ‘operating’ or ‘executing’ imply also capabilities, such as ‘operable’or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general-purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a computerized system or a similar term denotes an apparatus comprising one or more processors operable or operating according to one or more programs.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, without limiting, a module represents a part of a system, such as a part of a program operating or interacting with one or more other parts on the same unit or on a different unit, or an electronic component or assembly for interacting with one or more other components.

As used herein, without limiting, a process represents a collection of operations for achieving a certain objective or an outcome.

As used herein, the term ‘server’ denotes a computerized apparatus providing data and/or operational service or services to one or more other apparatuses.

The term ‘configuring’ and/or ‘adapting’ for an objective, or a variation thereof, implies using at least a software and/or electronic circuit and/or auxiliary apparatus designed and/or implemented and/or operable or operative to achieve the objective.

As used herein the term “configuring” and/or ‘adapting’ for an objective, or a variation thereof, implies using materials and/or components in a manner designed for and/or implemented and/or operable or operative to achieve the objective.

A device storing and/or comprising a program and/or data constitutes an article of manufacture. Unless otherwise specified, the program and/or data are stored in or on a non-transitory medium.

In the event electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

Unless otherwise specified, the terms “substantially”, “about” and/or “close” with respect to a magnitude or a numerical value implies within an inclusive range of −10% to +10% of the respective magnitude or value.

Unless otherwise specified, the terms “substantially”, “about” and/or “close” with respect to a dimension or extent, such as length, implies within an inclusive range of −10% to +10% of the respective dimension or extent.

Unless otherwise specified, the terms “substantially”, “about” and/or “close” imply at or in a region of, or close to a location or a part of an object relative to other parts or regions of the object.

When a range of values is recited, it is merely for convenience or brevity and includes all the possible sub ranges as well as individual numerical values within and about the boundary of that range. Any numeric value, unless otherwise specified, includes also practical close values enabling an embodiment or a method, and integral values do not exclude fractional values. A sub range values and practical close values should be considered as specifically disclosed values.

As used herein, ellipsis ( . . . ) between two entities or values denotes an inclusive range of entities or values, respectively. For example, A . . . Z implies all the letters from A to Z, inclusively.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

Terms in the claims that follow should be interpreted, without limiting, as characterized or described in the specification.

The descriptions of the various embodiments of the disclosed subject matter have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An optical diffuser comprising:
a compressible, elastic polymeric bulk having:
an exterior portion for diffusion of light received from a light emitting surface;
a planar mounting surface configured to seal against the light emitting surface; and
an atmospheric gas-filled cavity within the bulk, the cavity terminating at an opening within the planar mounting surface, wherein the cavity has a first volume when the bulk is at rest and a second, reduced volume when the bulk is compressed,
wherein, when the planar mounting surface is placed in full engagement with the light emitting surface so as to form a planar contact interface therewith, application of a momentary inward compressive force of the elastic polymeric bulk expels gas from within the cavity, and
wherein subsequent removal of the compressive force facilitates elastic recovery of the bulk, thereby to give rise to a partial vacuum within the cavity, and thereby to cause the optical diffuser to adhere to the light emitting surface under a suction force,
wherein the planar mounting surface is in a predetermined geometric configuration which corresponds to a geometric configuration of the light emitting surface.

2. The optical diffuser according to claim 1, wherein the optical diffuser is configured such that the suction force is greater than or equal to the maximum turning moment caused by the weight of the bulk and the angular disposition of the planar contact interface.

3. The optical diffuser according to claim 1, wherein the polymeric bulk is polyhedral, and the planar mounting surface is polygonal.

4. The optical diffuser according to claim 1, wherein the polymeric bulk is cylindrical and the planar mounting surface is circular.

5. A method of diffusing light received from a light emitting surface, which includes the steps of:
providing a compressible, elastic polymeric bulk having an exterior portion for diffusion of light received from a light emitting surface, a planar mounting surface, and an atmospheric gas-filled cavity within the bulk, the cavity terminating at an opening within the planar mounting surface;
applying an inward compressive force to the elastic polymeric bulk so as to expel gas from within the cavity;
holding the planar mounting surface against the light emitting surface in full engagement therewith; and
removing the compressive force from the bulk so as to facilitate elastic recovery thereof, thereby to give rise to a partial vacuum within the cavity, and to cause the optical diffuser to adhere to the light emitting surface under a suction force;
wherein the compressible, elastic polymeric bulk is in a predetermined geometric configuration which corresponds to a geometric configuration of the light emitting surface.

6. A system comprising:
a smart device comprising:
a touchscreen;
a processor coupled to the touchscreen, the processor configured to:
execute a light emitting application;
activate at least one light emitting portion of the touchscreen, designate a predetermined geometric configuration to the at least one emitting portion;
an optical diffuser comprising:
a compressible, elastic polymeric bulk having:
an exterior portion for diffusion of light received from a light emitting portion of the touchscreen;
a planar mounting surface configured to seal against the light emitting surface; and
an atmospheric gas-filled cavity within the bulk, the cavity terminating at an opening within the planar mounting surface, wherein the cavity has a first volume when the bulk is at rest and a second, reduced volume when the bulk is compressed,
wherein, when the planar mounting surface is placed in full engagement with the light emitting surface so as to form a planar contact interface therewith, application of a momentary inward compressive force of the elastic polymeric bulk expels gas from within the cavity, and
wherein subsequent removal of the compressive force facilitates elastic recovery of the bulk, thereby to give rise to a partial vacuum within the cavity, and thereby to cause the optical diffuser to adhere to the light emitting surface under a suction force;
wherein the predetermined geometric configuration of the light emitting portion corresponds to a geometric configuration of the optical diffuser.

7. The system according to claim 6, wherein the optical diffuser is configured such that the suction force is greater than or equal to the maximum turning moment caused by the weight of the bulk and the angular disposition of the planar contact interface.

8. The system according to claim 6, wherein the polymeric bulk is polyhedral, and the planar mounting surface is polygonal.

9. The system according to claim 6, wherein the polymeric bulk is cylindrical and the planar mounting surface is circular.

10. The system according to claim 6, wherein the processor is further configured to receive at least one command input to initiate the light emitting application.

11. The system according to claim 6, wherein the processor is further configured to display a selectable command for activation of the light emitting portion of the touchscreen.

12. The system according to claim 6, wherein the processor is further configured to display a timer setting, an audio volume setting and a brightness setting on the touchscreen.

13. The system according to claim 6, wherein the exterior portion is a diffractive optical material configured to diffract monochromatic light into a predetermined spatial configuration and intensity profile.

14. The system according to claim 6, wherein the planar mounting surface comprises an adhesive layer.
